(19) United States
(12) Patent Application Publication
(10) Pub. No.: US 2018/0183809 A1
(43) Pub. Date: Jun. 28, 2018

(54) UNIVERSAL LOGIN AUTHENTICATION SERVICE

(71) Applicants: Dennis Vadura, Trabuco Canyon, CA (US); Wei Kang Tsai, Irvine, CA (US)

(72) Inventors: Dennis Vadura, Trabuco Canyon, CA (US); Wei Kang Tsai, Irvine, CA (US)

(73) Assignee: Badu Networks, Inc., Irvine, CA (US)

(21) Appl. No.: 15/898,990

(22) Filed: Feb. 19, 2018

Related U.S. Application Data
(63) Continuation of application No. 14/271,279, filed on May 6, 2014.
(60) Provisional application No. 61/820,362, filed on May 7, 2013.

(51) Int. Cl. H04L 29/06

(52) U.S. Cl. CPC H04L 63/105; H04L 63/0815; H04L 63/0853; H04L 2463/082; H04L 63/083

(57) ABSTRACT

A system and method enables secure login at linked sites with a universal ID (UID) and possibly different or same password to linked identities. In such logins, a user stays at the linked login page, and the login name and password are sent to a UID provider for authentication. A UID provider may perform optional multi-factored authentication. A UID user is able to manage all his accounts, which are linked to his UID service, by changing the login names, passwords, security requirements, privacy requirements, and authentication requirements, with group-wise control. Successful or failed logins to linked accounts may be reported to a UID user. A UID user may disable logins at a group of linked accounts.

### CROSS REFERENCES TO RELATED APPLICATIONS

The present Application claims priority to U.S. Provisional Patent Application No. 61/820,362 filed on May 7, 2013, which is hereby incorporated by reference in its entirety. The present application is also a continuation of U.S. patent application Ser. No. 14/271,279, entitled “Universal Login Authentication Service,” filed on May 6, 2014.

### FIELD OF THE INVENTION

The present invention relates in general, to login authentication for online services, and particularly, to methods for login with a universal identifier.

### BACKGROUND OF THE INVENTION

Today it is common for an individual to interact with many online services that require secure login. Keeping track of many login IDs and passwords has become a burden to all—most people have difficulty remembering more than just a few login names and passwords. To reduce the pain, most websites provide email-based login-name discovery and password reset.

The problem is complicated by security and privacy concerns for online activities; identity theft, phishing, and cyber attacks have been and will continue to be a threat to both individuals and corporations. Consumers desire highly secure login with a great experience. However, great experience and high security contradict each other at their foundation. To most consumers, great experience means the same login name with the same password at all sites. However, for most online service providers, highly secure login means multi-factored authentication with unique and hard-to-remember passwords. Without employing a creative solution, it is simply impossible to have both at the same time.

A popular approach today is based on universal IDs. Many websites today allow a user to login with either a universal ID or an ID associated with a popular site. For example, OpenID is an open protocol standard that allows an OpenID service provider to serve as a 3^{rd}-party authenticator. To strengthen security, the OpenID standard requires a login name to conform to a URL (uniform resource locator), which is hard to memorize and enter, and it is not a good user experience.

While OpenID allows a user to login to any OpenID compliant sites with the same OpenID, the login process is unpleasant. To login, a user is redirected to a 3^{rd}-party identity-assertion provider for authentication. The issue is that it is possible for an identity-assertion provider to be unreliable or even malicious.

With OpenID, a user also loses management control over his identities, which are largely determined by his identity provider. The final issue is that redirecting the login to a 3^{rd}-party site is bad for branding as it provides free advertising to the 3^{rd}-party site.

A popular alternative is allowing login at different sites with a familiar account, for example, a Google or Facebook account. However, many users are not comfortable with such a solution—Google or Facebook accounts may reveal too much private information. In addition, consumers may be nervous about a single company acquiring too much private information through different sites.

None of the existing solutions provide a simple and universal login with highly secure authentication. While it is impossible to resolve the conflict between easy login and secure authentication, it is possible to minimize the pain of login while retaining a high level of security. In addition, a user should be given the ability to manage his personal identities and security requirements at different sites. Therefore, there is a need for highly secure universal-ID login with great user experience, and control over identities, security, privacy, and authentication.

### BRIEF SUMMARY OF THE INVENTION

It is an object of the present invention to provide a system and method to enable secure login at different websites with a single or multiple login IDs with single or multiple passwords, while allowing a user to manage his personal identities, security, privacy, and authentication requirements at different sites.

A linked website is installed with special software and is technically hooked up with a UID (universal ID) service provider to offer secure and UID login as an option. An account (or identity) at a linked site that is set up for UID login is said to be a linked account (or identity).

A user is able to login with a previously registered UID at a linked site to a linked account without leaving the login page or being redirected to an identity authentication site. Instead, a linked site forwards the user-entered UID and password to a server system operated by a UID service provider. The provider may employ a multi-factored method to authenticate the login. Having completed authentication, the provider sends a confirmation code (“approve” or “deny;” “authenticated” or “not authenticated”) back to a linked site.

Optionally, a linked site may connect to a UID provider through proxy servers installed on a premise close to or onsite at a facility hosting the linked site.

A user of a UID service is given a UID account with the UID service provider. Under that account, the user can register linked sites and linked accounts (identities) for which he has access rights. Under the UID account, the user may group all the registered linked sites and accounts according to user-specified criteria. A user is able to configure and specify UID-related options for all his linked accounts.

Under his UID account, a user may select the same UID or different UIDs for different groups of linked sites or accounts. A user may select the same password or different passwords for different groups of linked accounts, independent of the assigned UIDs.

Communications between a linked site, a UID service provider, and a user of UID service, may be encrypted. For an encrypted message, a one-time symmetric key may be used.

A linked site may report failed or successful logins at a linked account to a UID service provider, to the account owner, or to both. A UID service provider may send a message to inform a user of login activities at his linked accounts.

A UID user may disable login. Either automatically after a pre-set number of failed login attempts or manually, at a group of linked sites or accounts registered under his UID account. A UID user may disable a second-factor or third-factor authentication requirement for a group of linked sites or accounts.

A user may register a mobile or fixed communication device with a UID service provider. Such a user may use a UID app, or widget or browser extension or installed service, on a registered mobile or fixed communication device for second-factor or third-factor authentication.

Optionally, a UID provider may utilize biometric data from a mobile communication device or a wearable device, as second or third factor for authentication.

### BRIEF DESCRIPTION OF THE DRAWINGS

The above and other objects and features in accordance with the present invention will become apparent from the following descriptions of embodiments in conjunction with the accompanying drawings, and in which:

FIG. 1 is a flowchart illustrating the actions and data flow in a UID login, with a UID service provider, using a mobile communication device for second factor authentication.

FIG. 2 is a flowchart illustrating the steps for a UID service provider in a UID login, using a mobile communication device for second-factor authentication.

FIG. 3 is a table illustrating the grouping of registered linked sites for a user of a UID service, with high-level specification in group (category) name, security, privacy, and authentication method.

### DETAILED DESCRIPTION OF EXEMPLARY EMBODIMENTS

The present invention called UID (universal ID) service is a system and method to enable universal login. In the rest of this specification, a mobile communication device is a consumer device that allows a user to connect to the Internet wirelessly. A fixed communication device is a consumer device that allows a user to connect to the Internet through a fixed communication line.

A UID service provider is also known as a UID provider. A linked website is a site that has installed UID software and has established technical hook-up with a UID provider. The technical hook-up enables a linked site to offer UID login at the site, through a UID server system, which is usually operated by a UID provider. Optionally, a linked site may connect to a UID provider through proxy servers installed on a premise close to or onsite at a facility hosting the linked site. An account (or identity) that is enabled for UID login is said to be a linked account (or identity).

In accordance with one aspect of the present invention, a UID server system enables UID login authentication service to both individual users and linked websites. A linked website retains its login pages or boxes—this allows a linked site to continue its branding and advertising without interruption. On a login page or box, at least 2 buttons (or icons or banners) may be displayed. A first button is for normal (non-UID) login; a second button is for UID login through a UID provider. If a user chooses UID login, he has to use a username (or login name) that has been previously registered with a UID provider. A registered username or login name with a UID provider is called a UID.

If a user chooses UID login to a linked account at a linked site, the site forwards the username-password pair entered by the user to a UID server system. This forwarding triggers authentication of the login by a UID provider. Once authentication is completed, the UID provider sends a confirmation code (“approve” or “deny”; “authenticated” or “not authenticated”) back to the original site. The UID provider may send additional information regarding the user's identity or credentials to the original site.

A user of a UID service is given a UID account with the UID service provider. Under the UID account, the user can register linked sites and accounts (or identities) for which he has access rights. Under the UID account, the user may group all the registered linked sites and accounts according to user-specified criteria. A user may specify all or some UID-related options for all his linked accounts.

A user can login to his UID provider site directly to manage his UID account. A UID service allows multiple levels of security, privacy, and authentication, for each linked site or account that a user has registered with the provider. A user is allowed to specify or select his preferred security, privacy, and authentication requirements, for each group of linked sites or accounts that he has registered.

For sites with only casual concerns, a user may specify weak authentication. On the other hand, for banking and investment accounts, a UID provider may default to the strongest security, privacy, and authentication requirements.

A UID provider may set default security, privacy, and authentication levels for each linked site or account that a user has registered—however, a user may override the default choices made by his UID provider, provided the linked site allows it. A default authentication for UID login may be multi-factored or at least 2-factored.

An embodiment of a second-factor or third-factor authentication via a mobile or fixed communication device is as follows. First, a user registers a (personal) mobile or fixed communication device with a UID provider via a special UID app or browser extension. At the start of UID authentication, a UID provider sends a special authentication request to a UID app, or browser extension, which is installed on a registered mobile or fixed communication device. A UID app, or widget or browser extension or installed service, then prompts the user of the device to reply to the authentication request. The user must reply with “Yes” to allow the authentication to succeed.

Optionally, a UID provider may utilize biometric data from a mobile communication device or a wearable device. A wearable device is a wearable consumer item equipped with computing and communicating technology. Examples of wearable devices include Apple's iWatch and Google Glass.

Optionally, biometric data is used as an additional (or third) factor to confirm the identity of a user. For example, if a UID login is determined to be critical, a UID provider may require biometric data from a user using a mobile or wearable device as second or third factor to authenticate a UID login.

A user may disable a second-factor or third-factor authentication for linked sites or accounts that he deems to be less important. Optionally, a UID provider may send a message to a registered mobile or fixed device simply to inform a user that a successful or failed login has taken place.

A linked site may detect a failed normal (non-UID) login; alternatively, a UID provider may detect a failed UID login. In either case, a report of failed logins may be sent from a UID provider or from a linked site to a user whose linked account has recently experienced failed logins. The report may be sent via a UID app, or widget or browser extension or installed service, on a registered mobile or fixed communication device. The report may also be sent as an email, a text message, or via any other viable notification mechanism.

Optionally, fearing compromised credentials, a user may disable login for a group of linked sites or accounts. Optionally, a report of logins (either successful or failed) may be sent to a UID user, through a registered fixed or mobile communication device.

A UID provider may allow a user to manage his registered sites or linked accounts with a group-wise control. For example, a user may assign different or same UIDs for a group of linked sites or identities. A user may assign different or same password for a group of linked sites or linked identities, independent of the assigned UIDs.

The flexibility of group-wise user-specified login names and passwords make the UID login experience more pleasant and secure. For example, a user may use a single login name for a group of similar sites or accounts. A user may also use a single password for a group of similar sites or accounts.

For high-security sites such as stock trading and banking accounts, more than 2 factors may be used for UID authentication. A second or third factor is not restricted to utilizing a mobile or fixed communication device with a UID app or browser extension. Any other method may be used—for example, a telephone call or text message informing a UID user of a special one-time pass code.

A UID user may select a method for second-factor or third-factor authentication for each group of linked sites or linked accounts (or identities).

Optionally, all communications between a linked site, a UID provider, and a UID user are encrypted using a standard or common encryption technology. Optionally, a onetime symmetric key signed with a private key may be used in an encrypted message.

A linked site may designate itself to be UID-login-only. For these restricted sites, UID login is the only way for a user to be authenticated.

A UID service may provide management services to a UID user. Examples of management services may include: specifying and changing the UID for a group of linked sites or accounts; specifying and changing the password for a group of linked sites or accounts; enabling and disabling reporting of login activities at a group of linked sites or accounts; specifying and changing security, privacy, and authentication settings, associated with a group of linked sites or accounts; registering and deregistering a mobile or fixed device for authentication or reporting; reporting break-in attempts for a group of linked accounts, etc.

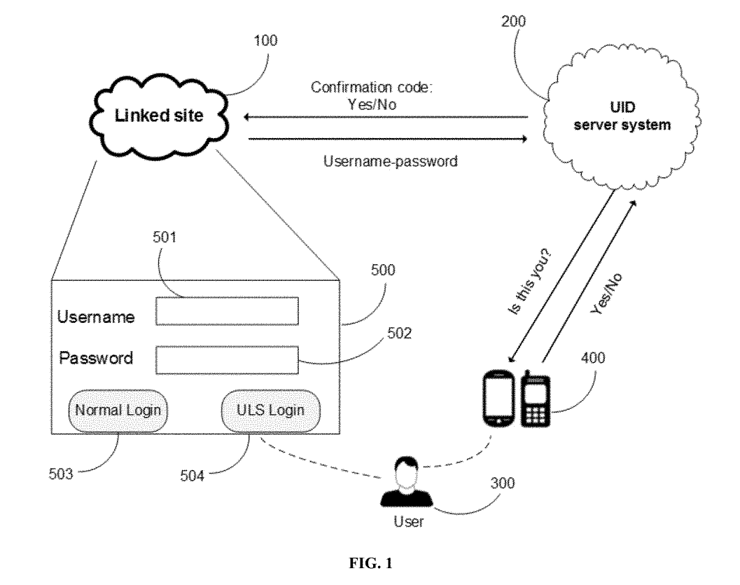

In FIG. 1, a linked site 100 exhibits a login page 500 to a user 300. On the login page, there is a box 501 for entering username, and a box 502 for entering password. Below the 2 boxes, there is button 503 for normal login, and another button 504 for UID login. If the user 300 selects UID login, site 100 sends the username-password pair entered by user 300 to the UID server system 200.

In this exemplary embodiment, the UID provider (server system) 200 performs a second factor authentication by sending an “Is this you” message to a UID app on a mobile communication device 400 held by the user 300. The user 300 confirms with a “Yes” message back to the UID provider 200, which in turn causes the provider 200 to send a confirmation code “Yes” back to the linked site 100.

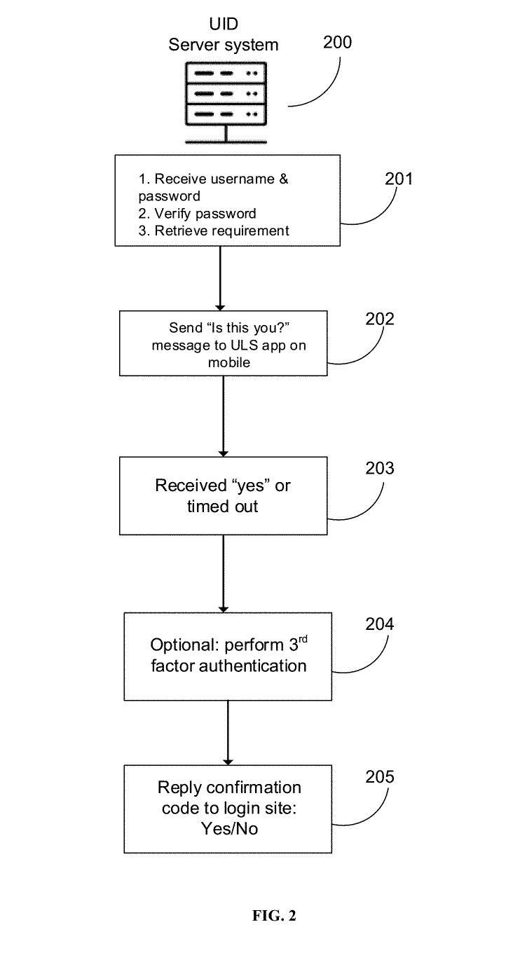

In FIG. 2, a UID server system 200 performs steps 201-205 for a UID login with 2-factor authentication. In step 201, the server system 200 receives a username-password pair from a linked site. The server system 200 verifies the password with the username. If and when the password checks, the UID provider 200 retrieves the security, privacy, and authentication requirements for the login site or linked account. In step 202, the UID provider sends a message “Is this you” to a UID app on a mobile communication device. In step 3, the UID provider 200 either times out while waiting or receives a “Yes” message through the UID app on the mobile device. In step 204, the UID provider 200 performs optional third factor authentication if required. In step 205, the UID provider 200 replies to the login site with a confirmation code: “Yes” or “No.”

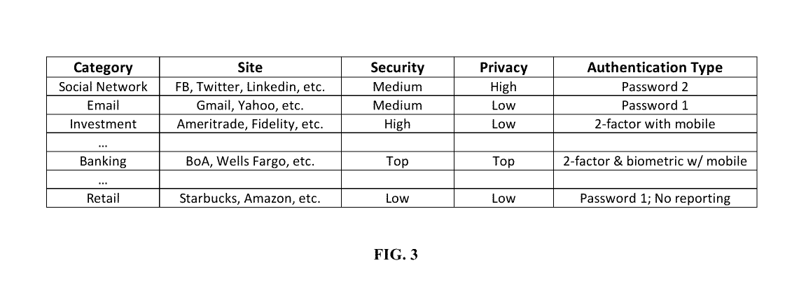

FIG. 3 is a table illustrating the grouping of registered linked sites (or accounts) for a user of a UID service. In this exemplary embodiment, the security level of sites or accounts is classified into top, high, medium, and low; the privacy level of sites or linked accounts is classified into high, medium and low. The authentication levels are varied: a group of sites or accounts may have the same password, another group may require 2-factor authentication, another group may require 3-factor authentication, yet another group may need only a general password, with no reporting requirement. The UID provider does not report failed or successful logins to a user's linked accounts with “no-reporting” requirement.

What is claimed is:

1. A machine-implemented method of third-party authentication with single-instance sign-on, comprising:
linking one or more online services with an authentication service, each said online service referred to as a linked service;
registering, by a user at the authentication service, one or more accounts (each account at a linked service), thereby each said account (referred to as an origin account) at a said linked service is linked to an account (referred to as a registered account) at the authentication service;
setting, by the user at the authentication service, a stored login name and a stored password for a registered account, the login name referred to as a linked login name for the registered account, and the password referred to as a linked password for the registered account; and
providing, jointly by the authentication service and a linked service, linked authentication, the authentication comprising:
entering, by a user at the linked service, a login name and a password, for signing onto an origin account at the linked service;
forwarding, by the linked service, the login name and password, both entered by the user, to the authentication service, without redirecting the user away from the linked service;
after the forwarding, authenticating, by the authentication service, the user by verifying that the forwarded login name matches a linked login name for the registered account linked to the origin account, and that the forwarded password matches a linked password for the registered account linked to the origin account;
after the forwarding, performing, by the authentication service as an option, a second-factor authentication to authenticate the user; and
after the authenticating, informing, by the authentication service, the linked service whether to allow the user to sign onto the origin account at the linked service or not.

2. The method of claim 1, wherein the user is further allowed to set a same linked login name shared by 2 or more registered accounts at the authentication service.

3. The method of claim 1, wherein the user is further allowed to set a same linked password shared by 2 or more registered accounts at the authentication service.

4. The method of claim 1, wherein the user is further allowed to set 2 or more linked login names for a registered account at the authentication service.

5. The method of claim 1, wherein the user is further allowed to set 2 or more linked passwords for a registered account at the authentication service.

6. A computer system for third-party authentication with single-instance sign-on, comprising:
at least one processor component;
at least one memory component;
at least one communication component, wherein the computer system is configured to:
link one or more online services with the computer system, each said online service referred to as a linked service;
allow a user to register, at the computer system, one or more accounts (each account at a linked service), thereby each said account (referred to as an origin account) at a said linked service is linked to an account (referred to as a registered account) at the computer system;
allow the user to set, at the computer system, a stored login name and a stored password for a registered account, the login name referred to as a linked login name for the registered account, and the password referred to as a linked password for the registered account; and
provide, together with a linked service, linked authentication, the authentication comprising:
entering, by a user at the linked service, a login name and a password, for signing onto an origin account at the linked service;
forwarding, by the linked service, the login name and password, both entered by the user, to the computer system, without redirecting the user away from the linked service;
after the forwarding, authenticating, by the computer system, the user by verifying that the forwarded login name matches a linked login name for the registered account linked to the origin account, and that the forwarded password matches a linked password for the registered account linked to the origin account;
after the forwarding, performing, by the computer system as an option, a second-factor authentication to authenticate the user; and
after the authenticating, informing, by the computer system, the linked service whether to allow the user to sign onto the origin account at the linked service or not.

7. The system of claim 6, wherein the user is further allowed to set a same linked login name shared by 2 or more registered accounts at the computer system.

8. The system of claim 6, wherein the user is further allowed to set a same linked password shared by 2 or more registered accounts at the computer system.

9. The system of claim 6, wherein the user is further allowed to set 2 or more linked login names for a registered account at the computer system.

10. The system of claim 6, wherein the user is further allowed to set 2 or more linked passwords for a registered account at the computer system.
